(19) United States
(12) Patent Application Publication
(10) Pub. No.: US 2008/0266489 A1
(43) Pub. Date: Oct. 30, 2008

(54) METHOD OF FABRICATING LIGHT-REFLECTOR IN LIQUID CRYSTAL DISPLAY DEVICE

(75) Inventors: Hiroshi SAKURAI, Kawasaki-shi (JP); Shusaku Kido, Kawasaki-shi (JP)

Correspondence Address: YOUNG & THOMPSON, 209 Madison Street, Suite 500, ALEXANDRIA, VA, 22314, US

(73) Assignee: NEC LCD TECHNOLOGIES, LTD, KAWASAKI-SHI (JP)

(21) Appl. No.: 12/108,102

(22) Filed: Apr. 23, 2008

(30) Foreign Application Priority Data
Apr. 26, 2007 (JP) 2007-117028

(51) Int. Cl. G02F 1/1335; G02B 1/10; G02B 5/10

(52) U.S. Cl. 349/67; 427/162

(57) ABSTRACT

A method of fabricating a light-reflector to be used in a light-reflection type or half-transmission type liquid crystal display device, includes (a) forming at least one organic film pattern, the organic film pattern being in the form of one of an island and a mesh, (b) exposing the organic film pattern to a steam atmosphere to melt and deform the organic film pattern such that the organic film pattern has a wavy surface, and (c) covering the organic film pattern with a light-reflecting electrode.

### BACKGROUND OF THE INVENTION

1. Field of the Invention

The invention relates to a method of fabricating a light-reflector to be used in a liquid crystal display device, a method of fabricating a liquid crystal display module including the light-reflector, a method of fabricating a liquid crystal display device including the light-reflector, a liquid crystal display module, as a part of a liquid crystal display device, including the light-reflector, and a liquid crystal display device including the light-reflector.

2. Description of the Related Art

A liquid crystal display device is grouped into a back-light (transmission) type liquid crystal display device, a half-transmission type liquid crystal display device, and a light-reflection type liquid crystal display device.

A back-light type liquid crystal display device is designed to include a backlight-emitting device (hereinafter, referred to as “the backlight”) therein. The backlight transmits a light, and the light passes through a liquid crystal layer to display desired images in a screen.

A light-reflection type liquid crystal display device is designed to include a light-reflector. An external light having entered the liquid crystal display device is reflected at the light-reflector, and the reflected external light passes through a liquid crystal layer to thereby display desired images in a screen.

A half-transmission type liquid crystal display device is designed to include both a backlight and a light-reflector. When only a weak external light can be obtained, a backlight transmits a light, which passes through a liquid crystal layer to thereby display desired images in a screen, whereas when a sufficient external light can be obtained, the external light having entered the liquid crystal display device is reflected at the light-reflector, and the reflected external light passes through a liquid crystal layer to thereby display desired images in a screen.

A light-reflection type liquid crystal display device is designed to include a light-reflecting electrode at which an external light is reflected, wholly in an area in each of pixels

A half-transmission type liquid crystal display device is designed to include a light-reflecting electrode at which an external light is reflected, partially in an area in each of pixels.

In order for a light-reflecting electrode to be able to provide sufficient light-reflection, a light-reflecting electrode is formed covering therewith a film having a wavy surface. The film underlying a light-reflecting film and having a wavy surface is necessary to have a profile of an inclination angle to ensure that external lights are adequately scattered.

In order to ensure the desired light-reflection, there have been suggested a lot of methods for fabricating a film having a wavy surface.

For instance, Japanese Patent Application Publication No. 2006-053303 has suggested a method of fabricating a film having a wavy surface.

FIGS. 1A and 1B illustrate steps to be carried out in the suggested method.

First, as illustrated in FIG. 1A, there is formed a first organic film pattern or a projection pattern 101 by means of a first lithography step. Herein, the first lithography step is comprised of steps of coating an organic film, exposing the organic film to a light through a mask for a first pattern, developing the organic film, and etching the organic film for removing portions having been exposed to a light (or portions not exposed to a light).

Then, as illustrated in FIG. 1B, a second organic film pattern or an interlayer film pattern 102 covering the first organic film pattern 101 therewith is formed by means of a second photolithography step. Herein, the second lithography step is comprised of steps of covering the first organic film pattern 101 with an organic film, exposing the organic film to a light through a mask for a second pattern, developing the organic film, and etching the organic film for removing portions having been exposed to a light (or portions not exposed to a light).

The resultant second organic film pattern 102 has a wavy surface.

Japanese Patent Application Publication No. 2002-169171 has suggested another method of fabricating a film having a wavy surface.

FIGS. 2A and 2B illustrate steps to be carried out in the suggested method.

First, as illustrated in FIG. 2A, an organic film pattern 103 comprised of first portions having a first thickness and second portions having a second thickness is formed by exposing an organic film to a light through a half-tone mask or twice exposing an organic film to a light.

Then, a thermal reflow step is carried out, that is, the organic film pattern 103 is heated for deformation. As a result, as illustrated in FIG. 2B, the organic film pattern 103 has a wavy surface.

However, the first-mentioned method is accompanied with a problem that the photolithography steps have to be carried out twice, resulting in an increase in a number of steps.

The second-mentioned method is accompanied with a problem that, when using a half-tone mask, an expensive half-tone mask has to be prepared, resulting in an increase in fabrication costs, or when carrying out photolithography steps twice, a number of steps to be carried out is inevitably increased.

Japanese Patent Application Publication No. 2001-188112 has suggested a method of fabricating a light-reflector, including forming a first wavy portion at a surface of a substrate, forming a second wavy portion in an area other than an area in which the first wavy portion is formed, the second wavy portion being fabricated by exposing a material of which the second wavy portion is composed to a light through a photomask, and developing the material, and forming a light-reflecting film on the second wavy portion.

Japanese Patent Application Publication No. 2001-67017 has suggested a method of fabricating an active matrix substrate, including a step of fabricating pixel electrodes in a matrix on an electrically insulating film covering an active device and an address line therewith. In a step of forming the electrically insulating film, a substrate on which a photosensitive resin is deposited is heated such that high-temperature portions and low-temperature portions are alternately disposed, to thereby evaporate solvent existing in the photosensitive resin. As a result, the photosensitive resin has a wavy surface, and the pixel electrode formed on the photosensitive resin also has a wavy surface.

Japanese Patent Application Publication No. 2006-221055 has suggested a light-reflector comprised of an organic film and a light-reflecting film formed on the organic film. First wavy portion is formed at a surface of the organic film. At least one of the wavy portions has an arcuate cross-section. Second wavy portion smaller than the first wavy portion is formed on the first wavy portion. The light-reflecting film has a shape reflecting a shape of the first and second wavy portions.

Japanese Patent Application Publication No. 10-246896 has suggested an array substrate including a substrate, non-linear devices arranged on the substrate in a matrix, an interlayer insulating film formed on the substrate to cover the non-linear devices therewith, and a light-reflection electrode formed on the interlayer insulating film. The interlayer insulating film has a wavy surface. The wavy surface of the interlayer insulating film has an average inclination angle in the range of 1 to 15 degrees.

### SUMMARY OF THE INVENTION

In view of the above-mentioned problems in the related art, it is an exemplary object of the present invention to provide a method of fabricating a light-reflector to be used in a light-reflection type or half-transmission type liquid crystal display device, which is capable of providing a film, which underlies a light-reflecting electrode, having a wavy surface, at a reduced number of steps and further at reduced fabrication costs.

It is further an exemplary object of the present invention to provide a method of fabricating a liquid crystal display module as a part of a liquid crystal display device, a method of fabricating a liquid crystal display device, a liquid crystal display module as a part of a liquid crystal display device, including a light-reflector fabricated in accordance with the above-mentioned method, and a liquid crystal display device including a light-reflector fabricated in accordance with the above-mentioned method, all of which are capable of doing the same.

In a first exemplary aspect of the present invention, there is provided a method of fabricating a light-reflector, including (a) forming at least one organic film pattern, the organic film pattern being in the form of one of an island and a mesh, (b) exposing the organic film pattern to a steam atmosphere to melt and deform the organic film pattern to have a wavy surface, and (c) covering the organic film pattern with a light-reflecting electrode.

In a second exemplary aspect of the present invention, there is provided a method of fabricating a liquid crystal display module as a part of a liquid crystal display device, including forming a gate electrode on a substrate, forming a gate insulating film on the substrate so as to cover the gate electrode therewith, forming a semiconductor layer on the gate insulating film, forming drain and source electrodes on the gate insulating film around the semiconductor layer, forming a passivation film on the gate insulating film so as to cover the semiconductor layer and the drain and source electrode therewith, forming a planar film on the passivation film, the planar film having a flat surface, forming at least one organic film pattern on the planar film, the organic film pattern being in the form of one of an island and a mesh, exposing the organic film pattern to a steam atmosphere to melt and deform the organic film pattern to have a wavy surface, and covering the organic film pattern with a light-reflecting electrode.

In a third exemplary aspect of the present invention, there is provided a method of fabricating a liquid crystal display device, including (a) fabricating a first substrate, (b) fabricating a second substrate, (c) disposing the first and second substrates in facing relating with each other with a space therebetween, and (d) introducing liquid crystal into the space, the step (a) including forming a gate electrode on a substrate, forming a gate insulating film on the substrate so as to cover the gate electrode therewith, forming a semiconductor layer on the gate insulating film, forming drain and source electrodes on the gate insulating film around the semiconductor layer, forming a passivation film on the gate insulating film so as to cover the semiconductor layer and the drain and source electrode therewith, forming a planar film on the passivation film, the planar film having a flat surface, forming at least one organic film pattern on the planar film, the organic film pattern being in the form of one of an island and a mesh, exposing the organic film pattern to a steam atmosphere to melt and deform the organic film pattern to have a wavy surface, and covering the organic film pattern with a light-reflecting electrode.

In a fourth exemplary aspect of the present invention, there is provided a liquid crystal display module as a part of a light-reflection type or half-transmission type liquid crystal display device, including a light-reflector fabricated by (a) forming at least one organic film pattern, the organic film pattern being in the form of one of an island and a mesh, (b) exposing the organic film pattern to a steam atmosphere to melt and deform the organic film pattern to have a wavy surface, and (c) covering the organic film pattern with a light-reflecting electrode.

In a fifth exemplary aspect of the present invention, there is provided a liquid crystal display device including a first substrate, a second substrate disposed in facing relation with the first substrate and spaced away from the first substrate, and a liquid crystal layer arranged in a space formed between the first and second substrates, wherein the first substrate includes a light-reflector fabricated by (a) forming at least one organic film pattern, the organic film pattern being in the form of one of an island and a mesh, (b) exposing the organic film pattern to a steam atmosphere to melt and deform the organic film pattern to have a wavy surface, and (c) covering said organic film pattern with a light-reflecting electrode.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIGS. 1A and 1B illustrate the steps to be carried out in the related method.

FIGS. 2A and 2B illustrate the steps to be carried out in the related method.

FIG. 3 is a cross-sectional view of a pixel in a TFT (thin film transistor) substrate as a part of a half-transmission type liquid crystal display device, in accordance with the first exemplary embodiment of the present invention.

FIGS. 4A to 4J are cross-sectional views showing the steps to be carried out in the method of fabricating the liquid crystal display module in accordance with the first exemplary embodiment.

FIG. 5 is a plan view illustrating an example of the organic film pattern.

FIG. 6 is a plan view illustrating another example of the organic film pattern.

FIG. 7 is a graph showing a relation between a period of time during which the organic film pattern is exposed to a steam atmosphere of organic solvent, and a degree to which the organic film pattern is deformed.

FIG. 8 is a cross-sectional view of a liquid crystal display device in accordance with the second exemplary embodiment of the present invention.

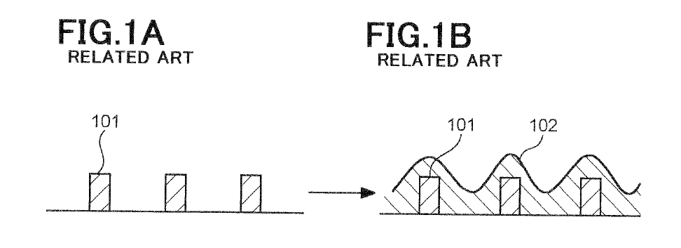

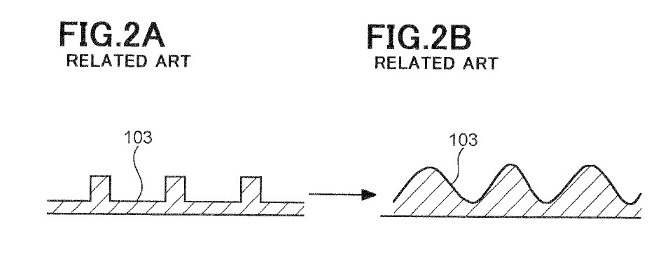

### DESCRIPTION OF THE EXEMPLARY EMBODIMENTS

Exemplary embodiments in accordance with the present invention will be explained hereinbelow with reference to drawings.

### First Exemplary Embodiment

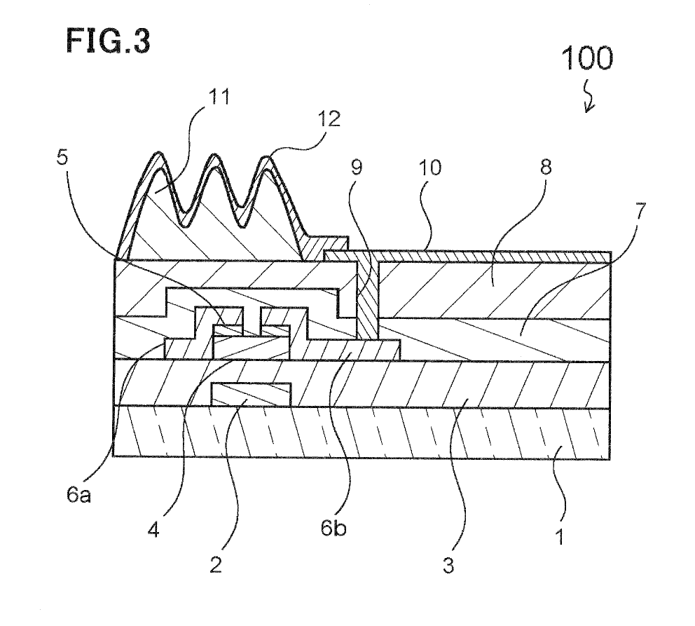

FIG. 3 is a cross-sectional view of a pixel in a TFT (thin film transistor) substrate 100 as a part of a half-transmission type liquid crystal display device, in accordance with the first exemplary embodiment of the present invention.

As illustrated in FIG. 3, the liquid crystal display module 100 is comprised of a glass substrate 1, a gate electrode formed on the glass substrate 1, a gate insulating film 3 formed on the glass substrate 1 so as to cover the gate electrode 2 therewith, a semiconductor layer 4 formed on the gate insulating film 3, the semiconductor layer 4 being composed of amorphous silicon (a-Si), for instance, a n+ a-Si layer 5 formed on the semiconductor layer 4, source and drain electrodes 6a and 6b formed on the gate insulating film 3 so as to cover both the semiconductor layer 4 and the n+ a-Si layer 5 therewith, a passivation film 7 formed on the gate insulating film 3 so as to cover the source and drain electrodes 6a and 6b therewith, a planar film 8 formed on the passivation film 7, a transparent electrode 10 formed on the planar film 8 and electrically connected to the drain electrode 6b through a via contact 9 filling therewith a contact hole formed throughout both the planar film 8 and the passivation film 7, a film 11 having a wavy surface, formed on the planar film 8 in an area other than an area in which the transparent electrode 10 is formed, and a light-reflecting electrode 12 covering the film 11 therewith and further covering an end of the transparent electrode 10 so as to be electrically connected to the transparent electrode 10.

Since the film 11 has a wavy surface, the light-reflecting electrode 12 covering the film 11 therewith also has a wavy surface. In other words, the light-reflecting electrode 12 has a wavy surface reflecting a wavy surface of the film 11.

A light-reflector in the liquid crystal display module 100 is defined by the film 11 and the light-reflecting electrode 12.

Hereinbelow is explained a method of fabricating the liquid crystal display module 100.

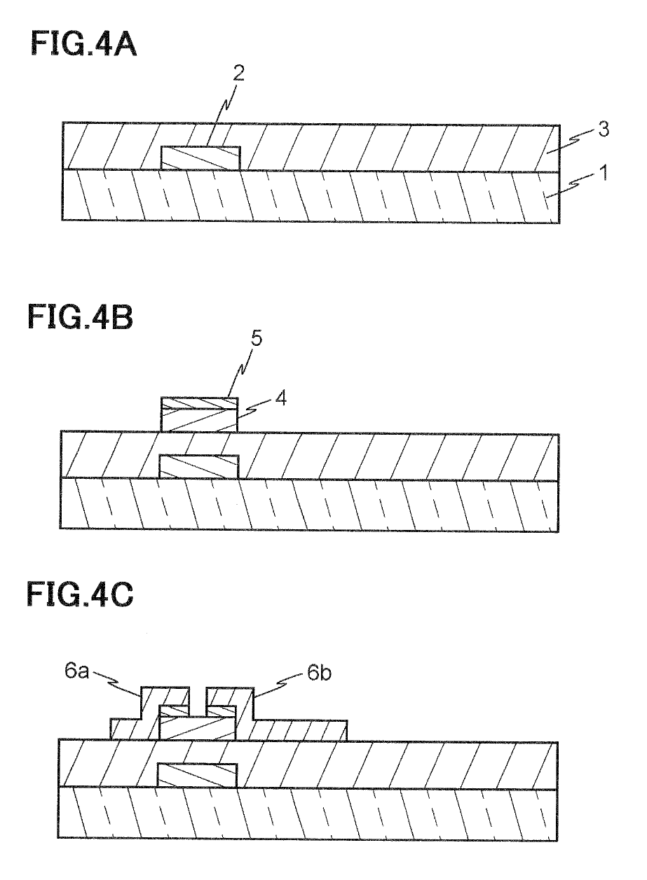

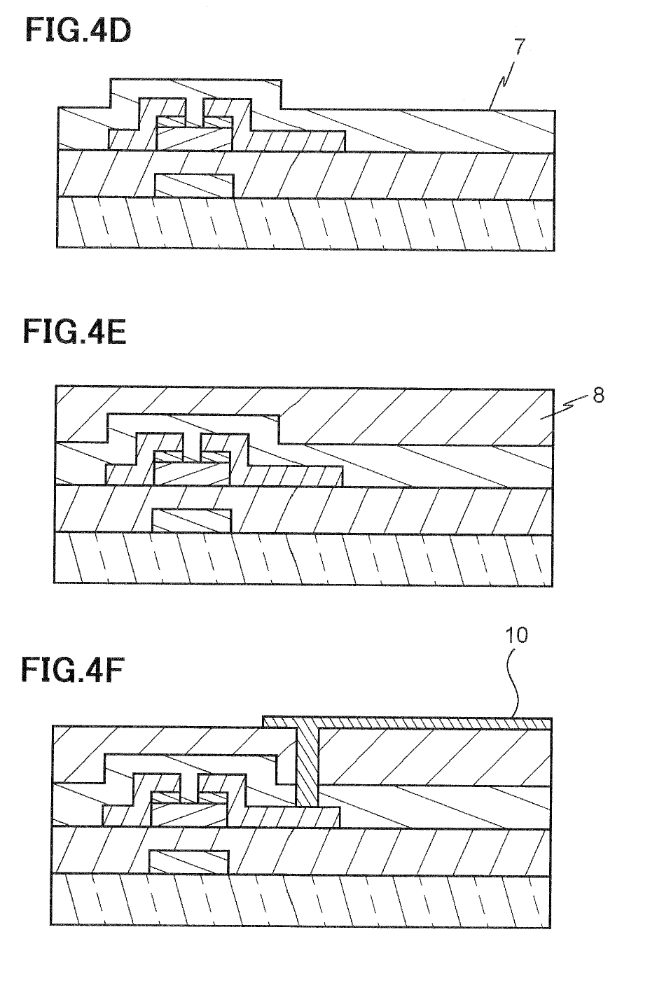

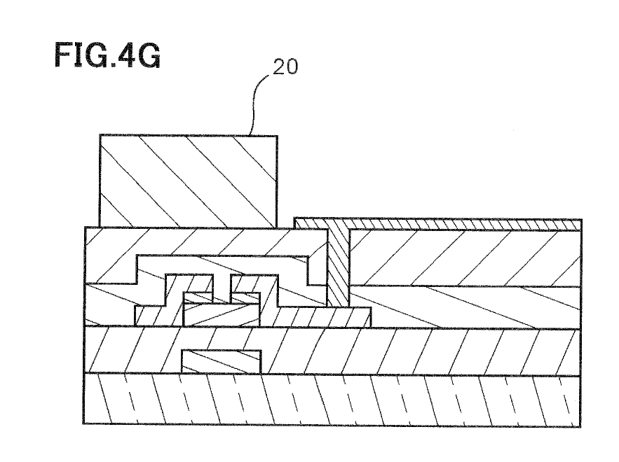

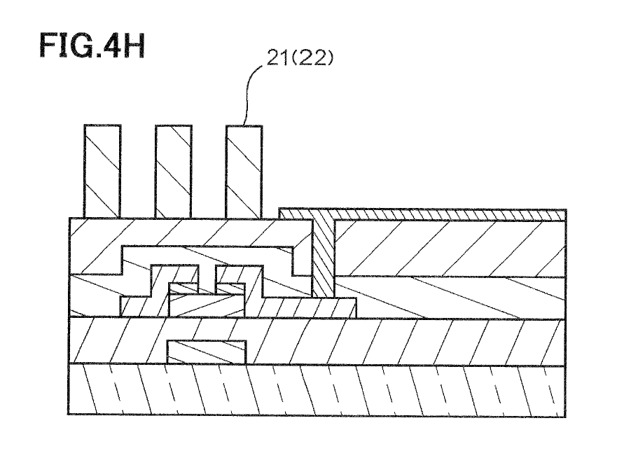

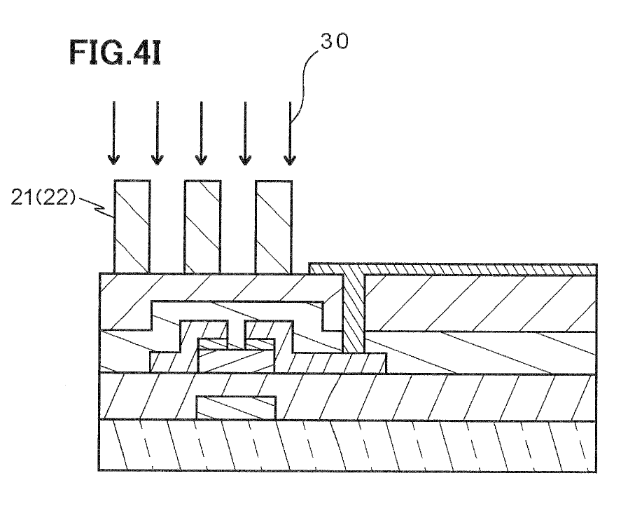

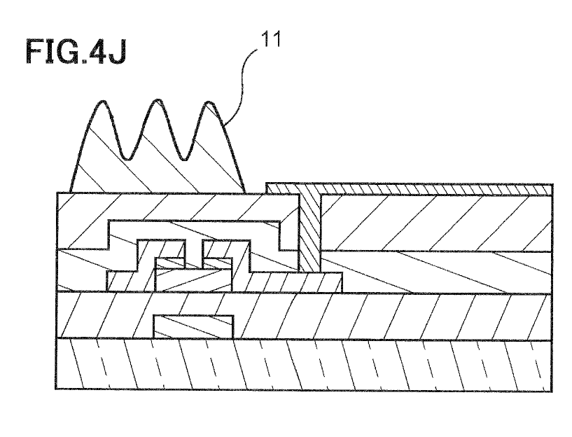

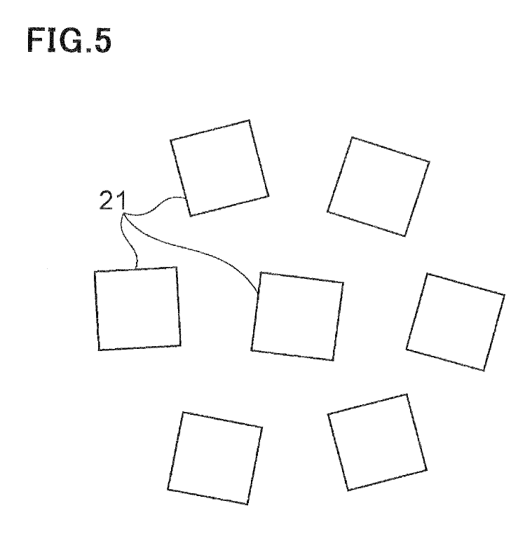

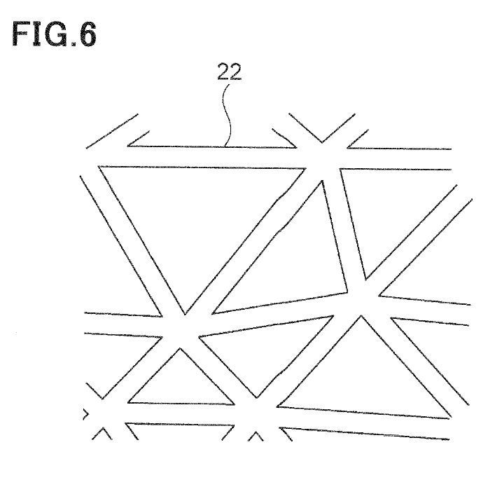

FIGS. 4A to 4I are cross-sectional views showing the steps to be carried out in the method of fabricating the liquid crystal display module 100.

First, as illustrated in FIG. 4A, the gate electrode 2 is formed on the glass substrate 1.

Then, the gate insulating film 3 is formed on the glass substrate 1 so as to cover the gate electrode 2 therewith.

Then, the semiconductor layer 4 and the n+ a-Si layer 5 are formed on the gate insulating film 3 in this order, as illustrated in FIG. 4B.

Then, an electrically conductive film is formed on the gate insulating film 3 so as to cover both the semiconductor layer 4 and the n+ a-Si layer 5 therewith.

Then, the electrically conductive film is etched into the source and drain electrodes 6a and 6b by means of a photolithography step, as illustrated in FIG. 4C.

Then, as illustrated in FIG. 4D, the passivation film 7 is formed on the gate insulating film 3 so as to cover the source and drain electrodes 6a and 6b, and the semiconductor layer 4 and the n+ a-Si layer 5 therewith.

Then, as illustrated in FIG. 4E, the planar film 8 is formed on the passivation film 7. As illustrated in FIG. 4E, the planar film 8 has a flat surface.

Then, a contact hole is formed throughout the planar film 8 and the passivation film 7 such that the contact hole reaches the drain electrode 6b.

Then, as illustrated in FIG. 4F, an electrically conductive transparent material is deposited over the planar film 8 so as to fill the contact hole therewith.

Then, as illustrated in FIG. 4F, the electrically conductive transparent material is etched into the transparent electrode 10.

Then, as illustrated in FIG. 4G, an organic film 20 is formed on the planar film 8 by spin coating in an area other than an area in which the transparent electrode 10 is formed. The organic film 20 has a thickness in the range of 1 to 3 micrometers both inclusive.

Then, the organic film 20 is pre-baked at a temperature in the range of 100 to 150 degrees centigrade both inclusive.

The organic film 20 is composed of either a material being soluble into organic solvent or a water-soluble material.

For instance, the organic film 20 composed of a material being soluble into organic solvent may contain an organic material and organic solvent, or an inorganic material and organic solvent.

As an organic material of which the organic film 20 being soluble into organic solvent is composed, there may be used resin such as acryl, polyimide and polyacrylamide, or organic polymer, for instance. As organic polymer, there may be used polyvinyl such as polyvinyl cinnamate, rubber such as a combination of cyclizing polyisoprene or cyclizing polybutadiene and bisazide, novolak resin such as a combination of cresol novolak resin and naphthoquinonediazide-5-sulfonate, or copolymer resin of acrylic acid, such as polyamide acid, for instance.

As an inorganic material of which the organic film 20 is composed, there may be used siloxane, polysiloxane, polysilane, carbosilane, silicon or inorganic glass, for instance.

As organic solvent, there may be used alcohol, ether, ester, ketone, glycol, alkylene glycol, or glycol ether, for instance.

As an organic material of which the organic film 20 being soluble into water is composed, there may be used polyacrylic acid, polyvinyl acetal, polyvinyl pyrrolidone, polyvinyl alcohol, polyethylene imine, polyethylene oxide, styrene-maleic anhydride copolymer, polyvinyl amine, polyaryl amine, water-soluble resin containing oxazoline group, water-soluble melamine resin, water-soluble urea resin, alkyd rein, and sulfonamide singly or in combination.

Then, a photoresist film is formed on the organic film 20. The photoresist film is exposed to a light, and then, is developed. As a result, there is formed a resist pattern in the form of an island or a mesh.

The island-shaped resist pattern is comprised of a plurality of patterns, for instance. Each of the patterns is in the form of a square having a side having a length in the range of 1 to 10 micrometers both inclusive. The patterns are disposed randomly such that they are spaced away from one another by a distance in the range of 2 to 30 micrometers both inclusive.

The mesh-shaped resist pattern is comprised of a plurality of lines connected randomly with one another in the form of a mesh. Each of the lines has a width in the range of 1 to 10 micrometers both inclusive, and a length in the range of 2 to 30 micrometers both inclusive.

It is preferable that each of openings of the mesh is in the form of a polygon such as a triangle, a rectangle and a hexagon. As an alternative, each of openings of the mesh may be defined with curves.

When each of the openings of the mesh is designed to be in the form of a polygon, it is preferable that apexes of each of the openings (that is, intersections of the lines with one another) are randomly disposed such that a polygon defined by each of the openings is not a regular polygon. If apexes of each of the openings are regularly disposed, interference fringes would be caused by reflected lights.

Then, the organic film 20 is dry-etched into the same pattern as the resist pattern. Then, the photoresist film is removed.

Thus, as illustrated in FIG. 4H, there is formed an organic film pattern 21 comprised of a plurality of islands, or an organic film pattern 22 in the form of a mesh.

FIG. 5 illustrates an example of the organic film pattern 21 comprised of a plurality of islands, and FIG. 6 illustrates an example of the organic film pattern 22 in the form of a mesh.

Then, as illustrated in FIG. 4I, the organic film pattern 21 or 22 is exposed to a steam atmosphere 30 having a function of melting the organic film pattern 21 or 22. By exposing the organic film pattern 21 or 22 to the steam atmosphere 30, the organic film pattern 21 or 22 is fluidized, and deformed into a film 11 having a smooth wavy surface, as illustrated in FIG. 4J.

Specifically, when the organic film pattern 21 or 22 is composed of a material which is soluble to organic solvent, the organic film pattern 21 or 22 is exposed to the steam atmosphere 30 of one of later-mentioned organic solvents. As a result, the organic film pattern 21 or 22 is deformed into the film 11 having a wavy surface, illustrated in FIG. 4J.

Similarly, when the organic film pattern 21 or 22 is composed of a material which is soluble to water, the organic film pattern 21 or 22 is exposed to a water-steam atmosphere or a steam atmosphere of aqueous solution principally containing water. As a result, the organic film pattern 21 or 22 is deformed into the film 11 having a wavy surface, illustrated in FIG. 4J.

When melted and deformed, the island-shaped organic film pattern 21 is joined with adjacent island-shaped organic film patterns, and thus, there is formed the film 11 having a wavy surface, illustrated in FIG. 4J.

When melted and deformed, each of the lines comprising the mesh-shaped organic film pattern 22 is joined with adjacent lines, and thus, there is formed the film 11 having a wavy surface, illustrated in FIG. 4J.

Thus, the film 11 having a wavy surface is formed on the planar film 8 in an area other than an area in which the transparent electrode 10 is formed, as illustrated in FIG. 4J.

List 1 shows organic solvents to be preferably used in the process of exposing the organic film pattern to organic solvent for melting and deforming the organic film pattern.

### [List 1]

Alcohol (R—OH)

Alkoxy alcohol

Ether (R—O—R, Ar—O—R, Ar—O—Ar)

Ester

Ketone

Glycol

Alkylene glycol

Glycol ether

In List 1, R indicates an alkyl group or a substitutional alkyl group, and Ar indicates a phenyl group or an aromatic ring other than a phenyl group.

List 2 shows specific organic solvents to be preferably used in the above-mentioned process.

### [List 2]

CH₃OH, C₂H₅OH, CH₃(CH₂)XOH

Isopropyl alcohol (IPA)

Ethoxy ethanol

Methoxy alcohol

Long-chain alkyl ester

Monoethanol amine (MEA)

Acetone

Acetyl acetone

Dioxane

Ethyl Acetate

Buthyl acetate

Toluene

Methylethyl ketone (MEK)

Diethyl ketone

Dimethyl sulfoxide (DMSO)

Methylisobutyl ketone (MIBK)

Butyl carbitol

n-butylacetate (nBA)

Gammer-butyro-lactone

Ethylcellosolve acetate (ECA)

Ethyl lactate

Pyruvate ethyl

2-heptanone (MAK)

3-methoxybutyl acetate

Ethylene glycol

Propylene glycol

Buthylene glycol

Ethylene glycol monoethyl ether

Diethylene glycol monoethyl ether

Ethylene glycol monoethyl ether acetate

Ethylene glycol monomethyl ether

Ethylene glycol monomethyl ether acetate

Ethylene glycol mono-n-buthyl ether

Polyethylene glycol

Polypropylene glycol

Polybuthylene glycol

Polyethylene glycol monoethyl ether

Polydiethylene glycol monoethyl ether

Polyethylene glycol monoethyl ether acetate

Polyethylene glycol monomethyl ether

Polyethylene glycol monomethyl ether acetate

Polyethylene glycol mono-n-buthyl ether

Methyl-3-methoxypropionate (MMP)

Propylene glycol monomethyl ether (PGME)

Propylene glycol monomethyl ether acetate (PGMEA)

Propylene glycol monopropyl ether (PGP)

Propylene glycol monoethyl ether (PGEE)

Ethyl-3-ethoxypropionate (FEP)

Dipropylene glycol monoethyl ether

Tripropylene glycol monoethyl ether

Polypropylene glycol monoethyl ether

Propylene glycol monomethyl ether propionate

3-methoxymethyl propionate

3-ethoxymethyl propionate

N-methyl-2-pyrrolidone (NMP)

When the organic film pattern 21 or 22 is composed of a water-soluble material, there may be used water or aqueous solution principally containing water in the process of exposing the organic film pattern thereto for melting and deforming the organic film pattern.

A degree at which the organic film pattern 21 or 22 is melted/deformed may be controlled by controlling a period of time during which the organic film pattern 21 or 22 is exposed to the steam atmosphere.

It is preferable that the wavy surface of the film 11 has an average inclination angle in the range of 3 to 15 degrees both inclusive.

A melting step of thermally melting the organic film pattern 21 or 22 may be additionally carried out prior to and/or subsequently to the step of exposing the organic film pattern 21 or 22 to a steam atmosphere for deforming the organic film pattern 21 or 22 into the film 11 having a wavy surface.

Then, the liquid crystal display module 100 is baked at a temperature in the range of 200 to 250 degrees centigrade for solidification, for instance, in an oven.

Then, the light-reflecting electrode 12 is formed covering the film 11 therewith and making contact at an end thereof with the transparent electrode 10. The light-reflecting electrode 12 is composed of an electrically conductive lustrous material. For instance, the light-reflecting electrode 12 is composed of aluminum.

Thus, there is completed the liquid crystal display module 100 illustrated in FIG. 3.

In the above-mentioned method, the transparent electrode 10 is formed prior to the formation of the film 11. As an alternative, the film 11 may be formed prior to the formation of the transparent electrode 10.

Furthermore, the light-reflecting electrode 12 is formed after the formation of the transparent electrode 10. Accordingly, the transparent electrode 10 is covered at an end thereof with the light-reflecting electrode 12. As an alternative, the light-reflecting electrode 12 may be formed prior to the formation of the transparent electrode 10, in which case, the light-reflecting electrode 12 is covered at an end thereof with the transparent electrode 10.

The above-mentioned process of deforming the organic film pattern by exposing the organic film pattern to a steam atmosphere makes it possible to deform the organic film pattern to a higher degree than a process of deforming the organic film pattern by heating the organic film pattern. Furthermore, it is possible to readily control the degree to which the organic film pattern is deformed, by controlling a period of time during which the organic film pattern is exposed to a steam atmosphere. Thus, the above-mentioned process of deforming the organic film pattern by exposing the organic film pattern to a steam atmosphere provides the flexible designability in forming the film 11 having a wavy surface.

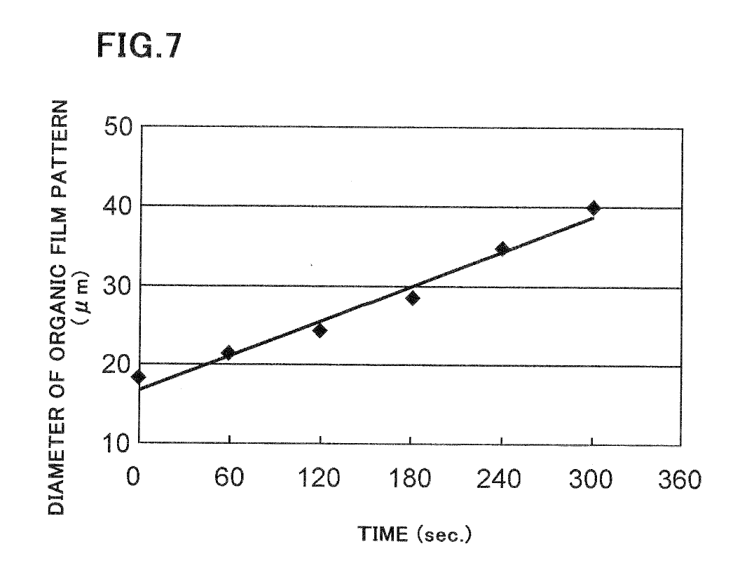

FIG. 7 is a graph showing a relation between a period of time during which the organic film pattern is exposed to a steam atmosphere of organic solvent, and a diameter of the organic film pattern.

In FIG. 7, a diameter of the organic film pattern is equivalent to a degree to which the organic film pattern is deformed. Specifically, a greater diameter of the organic film pattern indicates a higher degree to which the organic film pattern is deformed, and a smaller diameter of the organic film pattern indicates a smaller degree to which the organic film pattern is deformed.

As illustrated in FIG. 7, as the organic film pattern is exposed to a steam atmosphere of organic solvent for a longer period of time, the organic film patter is deformed to a higher degree, that is, the organic film pattern would have a greater diameter.

FIG. 7 shows that it is possible to linearly control a degree to which the organic film pattern is deformed, by controlling a period of time during which the organic film pattern is exposed to a steam atmosphere of organic solvent.

In the liquid crystal display module 100 in accordance with the first exemplary embodiment, it is possible to fabricate the film 11 to have a wavy surface having a profile of desired inclination angle, by exposing the organic film pattern, which was patterned into an island or a mesh by once carrying out a photolithography step, to a steam atmosphere of organic solvent to thereby cause the organic film pattern to absorb organic solvent thereinto for deformation.

As an alternative, it is possible to fabricate the film 11 to have a wavy surface having a profile of desired inclination angle, by exposing the organic film pattern, which was patterned into an island or a mesh by once carrying out a photolithography step, to a steam atmosphere of water or aqueous solution principally containing water to thereby cause the organic film pattern to absorb organic solvent thereinto for deformation.

In the liquid crystal display module 100 in accordance with the first exemplary embodiment, an organic film is etched into the organic film pattern through a photoresist pattern. If an organic film is composed of a photosensitive material, it would be possible to pattern the organic film into an island or a mesh by exposing the organic film to a light and developing the organic film pattern, in which case, the organic film pattern can be formed into the film 11 having a wavy surface, by exposing the organic film pattern to a steam atmosphere of organic solvent.

In FIG. 5, the organic film pattern 21 is in the form of a square. The organic film pattern 21 may be in the form of a rectangle, a line (having a width in the range of 1 to 10 micrometers both inclusive and a length in the range of 2 to 30 micrometers both inclusive, for instance) or any island shape.

In the first exemplary embodiment, the liquid crystal display module 100 is designed to be used for a half-transmission type liquid crystal display device. As an alternative, the liquid crystal display module 100 may be designed to be used for a light-reflection type liquid crystal display device, in which case, the liquid crystal display module 100 does not include the transparent electrode 10, and the planar film 8 is entirely covered with the film 11 which is further covered with the light-reflecting electrode 12.

### Second Exemplary Embodiment

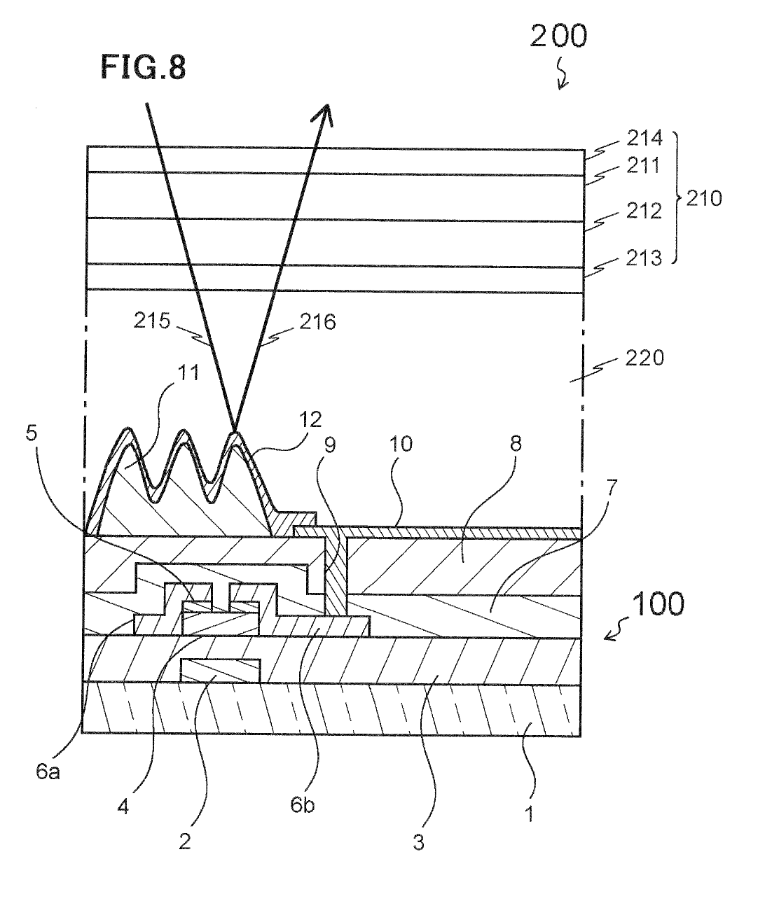

FIG. 8 is a cross-sectional view of a liquid crystal display device 200 in accordance with the second exemplary embodiment of the present invention.

The liquid crystal display device 200 is of a half-transmission type one.

The liquid crystal display device 200 is comprised of a first substrate comprised of the liquid crystal display module 100, a second substrate 210 disposed in facing relation with the liquid crystal display module 100 and spaced away from the liquid crystal display module 100, and a liquid crystal layer 220 sandwiched between the liquid crystal display module 100 and the second substrate 210.

The second substrate 210 is comprised of a glass substrate 211, a color filter 212 formed on a first surface of the glass substrate 211, a common electrode 213 formed on the color filter 212, and a polarizing plate 214 formed on a second surface of the glass substrate 211.

A voltage is applied to liquid crystal molecules in the liquid crystal layer 220 through the common electrode 213.

liquid crystal molecules in the liquid crystal layer 220 are controlled by a voltage applied across the Liquid crystal display module 100 and the second substrate 210.

An incident light 215 passing through the second substrate 210 and the liquid crystal layer 220 is reflected at the light-reflecting electrode 12 having a wavy surface, and then, passes again through the liquid crystal layer 220 and the second substrate 210, and leaves the liquid crystal display device 200 as an out-going light 216.

The liquid crystal display device 200 is fabricated as follows.

First, the Liquid crystal display module 100 is fabricated in accordance with the process explained in the first exemplary embodiment.

Then, the second substrate 210 is fabricated in accordance with the following steps.

First, the color filter 212 is formed on a first surface of the glass substrate 211. A first surface of the glass substrate 211 indicates a surface facing the Liquid crystal display module 100.

Then, the common electrode 213 is formed on the color filter 212.

Then, the polarizing plate 214 is formed on a second surface of the glass substrate 211. A second surface of the glass substrate 211 indicates a surface opposite to the first surface.

Then, the Liquid crystal display module 100 and the second substrate 210 are disposed in facing relation with each other such that there is formed a space therebetween. For instance, spacers are sandwiched between the Liquid crystal display module 100 and the second substrate 210.

Then, liquid crystal is introduced into the space.

Thus, there is completed the liquid crystal display device 200 illustrated in FIG. 8.

Since the liquid crystal display device 200 includes the liquid crystal display module 100 in accordance with the first exemplary embodiment, the liquid crystal display device 200 can have the advantages provided by the liquid crystal display module 100.

The liquid crystal display device 200 in accordance with the second exemplary embodiment is fabricated as a half-transmission type liquid crystal display device. As an alternative, the liquid crystal display device 200 may be fabricated as a light-reflection type liquid crystal display device, in which case, the liquid crystal display module 100 does not include the transparent electrode 10, and the planar film 8 is entirely covered with the film 11 which is further covered with the light-reflecting electrode 12.

Apart from the above-mentioned exemplary embodiments, the method of fabricating a light-reflector to be used in a light-reflection type or half-transmission type liquid crystal display device, in accordance with the present invention has preferred exemplary embodiments as follows.

In a preferred embodiment, a plurality of organic film patterns is fabricated in the form of an island in the step of the organic film pattern, each of the organic film patterns being in the form of a square having a side having a length in the range of 1 to 10 micrometers both inclusive, the organic film patterns being disposed randomly such that they are spaced away from one another by a distance in the range of 2 to 30 micrometers both inclusive.

In a preferred embodiment, the organic film pattern is composed of a material soluble into organic solvent, and the steam atmosphere is comprised of steam of organic solvent.

In a preferred embodiment, the organic film pattern is composed of a water-soluble material, and the steam atmosphere is comprised of one of water vapor and steam of aqueous solution principally containing water.

In a preferred embodiment, the wavy surface has an average inclination angle in the range of 3 to 15 degrees both inclusive.

In a preferred embodiment, the method further includes a melting step of thermally melting the organic film pattern, the melting step being carried out prior to and/or subsequently to the step of exposing the organic film pattern to a steam atmosphere.

In a preferred embodiment, the method further includes pre-baking the organic film pattern prior to the step of exposing the organic film pattern to a steam atmosphere.

In a preferred embodiment, the organic film pattern is pre-baked at a temperature in the range of 100 to 150 degrees centigrade both inclusive.

In a preferred embodiment, a period of time during which the organic film pattern is exposed to the steam atmosphere is controlled to control the degree at which the organic film pattern is melted and deformed.

In a preferred embodiment, the method further includes baking the organic film pattern to solidify the organic film pattern, in which case, it is preferable that the organic film pattern is baked at a temperature in the range of 200 to 250 degrees centigrade.

In a preferred embodiment, the organic film pattern is composed of a photosensitive material.

In a preferred embodiment, the organic film pattern formed in the step of forming the organic film pattern is comprised of a plurality of lines connected randomly with one another in the mesh, each of the lines having a width in the range of 1 to 10 micrometers both inclusive, and a length in the range of 2 to 30 micrometers both inclusive.

In a preferred embodiment, the mesh is defined with a plurality of polygons except a regular polygon.

Apart from the above-mentioned exemplary embodiments, the method of fabricating a liquid crystal display module as a part of a liquid crystal display device, in accordance with the present invention has preferred exemplary embodiments as follows.

In a preferred embodiment, the method further includes forming a transparent electrode on the planar film in an area other than an area in which the organic film pattern is formed, the transparent electrode being electrically connected to one of the source and drain electrodes through a via-contact, and further electrically connected to the light-reflecting electrode.

Apart from the above-mentioned exemplary embodiments, the method of fabricating a liquid crystal display device, in accordance with the present invention has preferred exemplary embodiments as follows.

In a preferred embodiment, the step of fabricating the first substrate further includes forming a transparent electrode on the planar film in an area other than an area in which the organic film pattern is formed, the transparent electrode being electrically connected to one of the source and drain electrodes through a via-contact, and further electrically connected to the light-reflecting electrode.

The exemplary advantages obtained by the above-mentioned exemplary embodiments are described hereinbelow.

In the above-mentioned exemplary embodiments, the island-shaped or the mesh-shaped organic film pattern is exposed to a steam atmosphere, resulting in that the organic film patterns are melted and deformed into a film having a wavy surface. Then, the organic film pattern is covered with a light-reflecting electrode. Thus, there is formed a light-reflector to be used for a half-transmission type or a light-reflection type liquid crystal display device. It is possible to fabricate a light-reflector without an increase in a number of fabrication steps and further without precise control to a process of fabricating a light-reflector.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

This application is based upon and claims the benefit of priority from Japanese Patent Application No. 2007-117028 filed on Apr. 26, 2007, the entire disclosure of which, including specification, claims, drawings and summary, is incorporated herein by reference in its entirety.

What is claimed is:

1. A method of fabricating a light-reflector to be used in a liquid crystal display device, comprising:
(a) forming at least one organic film pattern, said organic film pattern being in the form of one of an island and a mesh;
(b) exposing said organic film pattern to a steam atmosphere to melt and deform said organic film pattern to have a wavy surface; and
(c) covering said organic film pattern with a light-reflecting electrode.

2. The method as set forth in claim 1, wherein a plurality of organic film patterns is fabricated in an island form in said step (a), each of said organic film patterns being in the form of a square having a side having a length in the range of 1 to 10 micrometers both inclusive, said organic film patterns being disposed randomly such that they are spaced away from one another by a distance in the range of 2 to 30 micrometers both inclusive.

3. The method as set forth in claim 1, wherein said organic film pattern is composed of a material soluble into organic solvent, and said steam atmosphere is comprised of steam of organic solvent.

4. The method as set forth in claim 1, wherein said organic film pattern is composed of a water-soluble material, and said steam atmosphere is comprised of one of water vapor and steam of aqueous solution principally containing water.

5. The method as set forth in claim 1, wherein said wavy surface has an average inclination angle in the range of 3 to 15 degrees both inclusive.

6. The method as set forth in claim 1, further comprising a melting step of thermally melting said organic film pattern, said melting step being carried out prior to and/or subsequently to said step (b).

7. The method as set forth in claim 1, further comprising pre-baking said organic film pattern prior to said step (b).

8. The method as set forth in claim 7, wherein said organic film pattern is pre-baked at a temperature in the range of 100 to 150 degrees centigrade both inclusive.

9. The method as set forth in claim 1, wherein a period of time during which said organic film pattern is exposed to said steam atmosphere is controlled to control a degree at which said organic film pattern is melted and deformed.

10. The method as set forth in claim 1, further comprising baking said organic film pattern to solidify said organic film pattern.

11. The method as set forth in claim 10, wherein said organic film pattern is baked at a temperature in the range of 200 to 250 degrees centigrade.

12. The method as set forth in claim 1, wherein said organic film pattern is composed of a photosensitive material.

13. The method as set forth in claim 1, wherein said organic film pattern formed in said step (a) is comprised of a plurality of lines connected randomly with one another in the form of a mesh, each of said lines having a width in the range of 1 to 10 micrometers both inclusive, and a length in the range of 2 to 30 micrometers both inclusive.

14. The method as set forth in claim 1, wherein said mesh is defined with a plurality of polygons except a regular polygon.

15. A method of fabricating a liquid crystal display module as a part of a liquid crystal display device, comprising:
forming a gate electrode on a substrate;
forming a gate insulating film on said substrate so as to cover said gate electrode therewith;
forming a semiconductor layer on said gate insulating film;
forming drain and source electrodes on said gate insulating film around said semiconductor layer;
forming a passivation film on said gate insulating film so as to cover said semiconductor layer and said drain and source electrode therewith;
forming a planar film on said passivation film, said planar film having a flat surface;
forming at least one organic film pattern on said planar film, said organic film pattern being in the form of one of an island and a mesh;
exposing said organic film pattern to a steam atmosphere to melt and deform said organic film pattern such that said organic film pattern has a wavy surface; and
covering said organic film pattern with a light-reflecting electrode.

16. The method as set forth in claim 15, further comprising forming a transparent electrode on said planar film in an area other than an area in which said organic film pattern is formed, said transparent electrode being electrically connected to one of said source and drain electrodes through a via-contact, and further electrically connected to said light-reflecting electrode.

17. A method of fabricating a liquid crystal display device, comprising:
(a) fabricating a first substrate;
(b) fabricating a second substrate;
(c) disposing said first and second substrates in facing relating with each other with a space therebetween; and
(d) introducing liquid crystal into said space,
said step (a) including:
forming a gate electrode on a substrate;
forming a gate insulating film on said substrate so as to cover said gate electrode therewith;
forming a semiconductor layer on said gate insulating film;
forming drain and source electrodes on said gate insulating film around said semiconductor layer;
forming a passivation film on said gate insulating film so as to cover said semiconductor layer and said drain and source electrode therewith;
forming a planar film on said passivation film, said planar film having a flat surface;
forming at least one organic film pattern on said planar film, said organic film pattern being in the form of one of an island and a mesh;
exposing said organic film pattern to a steam atmosphere to melt and deform said organic film pattern such that said organic film pattern has a wavy surface; and
covering said organic film pattern with a light-reflecting electrode.

18. The method as set forth in claim 17, wherein said step (a) further includes forming a transparent electrode on said planar film in an area other than an area in which said organic film pattern is formed, said transparent electrode being electrically connected to one of said source and drain electrodes through a via-contact, and further electrically connected to said light-reflecting electrode.

19. A liquid crystal display module, including a light-reflector fabricated by:
(a) forming at least one organic film pattern, said organic film pattern being in the form of one of an island and a mesh;
(b) exposing said organic film pattern to a steam atmosphere to melt and deform said organic film pattern such that said organic film pattern has a wavy surface; and
(c) covering said organic film pattern with a light-reflecting electrode.

20. A liquid crystal display device comprising:
a first substrate;
a second substrate disposed in facing relation with said first substrate and spaced away from said first substrate; and
a liquid crystal layer arranged in a space formed between said first and second substrates,
wherein said first substrate includes a light-reflector fabricated by:
(a) forming at least one organic film pattern, said organic film pattern being in the form of one of an island and a mesh;
(b) exposing said organic film pattern to a steam atmosphere to melt and deform said organic film pattern such that said organic film pattern has a wavy surface; and
(c) covering said organic film pattern with a light-reflecting electrode.
